(19) United States
(12) Patent Application Publication
(10) Pub. No.: US 2019/0019094 A1
(43) Pub. Date: Jan. 17, 2019

(54) DETERMINING SUITABILITY FOR PRESENTATION AS A TESTIMONIAL ABOUT AN ENTITY

(71) Applicant: Google Inc., Mountain View, CA (US)

(72) Inventors: Advay Mengle, Sunnyvale, CA (US); Anna Goldie, Cambridge, MA (US); Stephen Walters, San Francisco, CA (US); Anna Patterson, Saratoga, CA (US); Jindong Chen, Hillsborough, CA (US); Leo Shamis, Mountain View, CA (US); Isaac Noble, Santa Cruz, CA (US); Dimitris Margaritis, Cupertino, CA (US); Clement Nodet, San Francisco, CA (US); Charmaine Cynthia Rose D'Silva, Sunnyvale, CA (US)

(21) Appl. No.: 14/709,451

(22) Filed: May 11, 2015

Related U.S. Application Data
(60) Provisional application No. 62/076,924, filed on Nov. 7, 2014.

(51) Int. Cl. G06N 5/04; G06N 99/00

(52) U.S. Cl. CPC G06N 5/04; G06N 99/005

(57) ABSTRACT

Methods and apparatus are described herein for selecting, from one or more electronic data sources, a candidate textual statement associated with an entity, identifying one or more attributes of the candidate textual statement; and determining, based on the identified one or more attributes of the candidate textual statement, a measure of suitability of the candidate textual statement for presentation as a testimonial about the entity.

### BACKGROUND

Entities such as products, product creators, and/or product vendors may be discussed in various locations online by individuals associated with the entities and/or by other individuals that are exposed to the entity. For example, an online review of a particular product may be in text, audio, and/or video form. Oftentimes such reviews are accompanied by a comments section where users may leave comments about the product and/or the review. As another example, a creator of a downloadable product such as a software application for mobile computing devices (often referred to as “apps”) may prepare and post a description of the software application on an online marketplace of apps. Oftentimes such descriptions are accompanied by comments sections and/or user reviews. These various entity discussions may include information about entities that may not have been provided or generated, for instance, by individuals associated with the entities.

### SUMMARY

The present disclosure is generally directed to methods, apparatus and computer-readable media (transitory and non-transitory) for determining suitability of textual statements associated with an entity for presentation as testimonials about the entity. As used herein, a “textual statements associated with an entity,” or a “snippet,” may be a clause of a multi-clause sentence, an entire sentence, and/or a sequence of sentences (e.g., a paragraph). Textual statements associated with entities may be extracted from, for instance, entity descriptions provided by individuals or organizations associated with the entities (e.g., a description of an app by an app creator posted on an online marketplace or social network), ad creatives (e.g., presented as “sponsored search results” returned in response to a search engine query), reviews about entities (e.g., a review by a critic in an online magazine or on a social network), and so forth. A “textual statement associated with entity” may also include user comment associated with entity descriptions and/or textual reviews about entities. Of course, these are just examples; textual statements associated with entities may come from other sources as well, such as online forums, chat rooms, review clearinghouses, and so forth.

A “testimonial” refers to a textual statement associated with an entity that may be relatively concise, informative, and/or self-contained. A testimonial often may be a sentence or two in length, although a short paragraph may serve as a suitable testimonial in some instances. In various implementations, textual statements associated with an entity may be analyzed to determine their suitability for presentation as testimonials about the entity (also referred to herein as “testimonial-ness”). In some implementations, measures or scores of testimonial-ness may be determined for one or more textual statements about an entity based on various criteria. Based on these measures or scores, textual statements associated with the entity may be selected for presentation in various scenarios, such as accompanying an advertisement for a particular entity, accompanying search results that are in some way relatable to the entity, and so forth.

In some implementations, a computer implemented method may be provided that includes the steps of: selecting, by one or more processors from one or more electronic data sources, a candidate textual statement associated with an entity; identifying, by one or more of the processors, one or more attributes of the candidate textual statement; and determining, by one or more of the processors based on the identified one or more attributes of the candidate textual statement, a measure of suitability of the candidate textual statement for presentation as a testimonial about the entity.

This method and other implementations of technology disclosed herein may each optionally include one or more of the following features.

In some implementations, identifying one or more attributes of the candidate textual statement may include determining, by one or more of the processors, a measure of sarcasm expressed by the candidate textual statement. In various implementations, identifying one or more attributes of the candidate textual statement may include determining, by one or more of the processors based on content of the candidate textual statement, an inferred sentiment orientation associated with the candidate textual statement. In some implementations, the method may include comparing the inferred sentiment orientation of the candidate textual statement to an explicit sentiment orientation associated with the candidate textual statement to determine a measure of sarcasm associated with the candidate textual statement.

In various implementations, the identifying may include determining, by one or more of the processors, one or more structural details underlying the candidate textual statement. In various implementations, the identifying may include identifying, by one or more of the processors, one or more characteristics of the entity expressed in the candidate textual statement. In various implementations, the determining may include comparing, by one or more of the processors, the one or more identified characteristics of the entity expressed in the candidate textual statement with known characteristics of the entity.

In various implementations, the determining may be performed using a machine learning classifier. In various implementations, the method may further include training the machine learning classifier using portions of entity descriptions deemed likely to be suitable for presentation as a testimonial about the entity. In various implementations, the portions of entity descriptions deemed likely to be suitable for presentation as a testimonial about the entity may include portions at predetermined locations within the entity descriptions. In various implementations, the predetermined locations within the entity descriptions include first sentences of the entity descriptions. In various implementations, training the machine learning classifier may include assigning different weights to different portions of the entity descriptions based on locations of the different portions within the entity descriptions. In various implementations, the portions of entity descriptions deemed likely to be suitable for presentation as a testimonial about the entity may include portions enclosed in quotations or having a particular format.

In various implementations, the method may further include selecting, by one or more of the processors, the candidate textual statement for presentation as a testimonial about the entity based on the measure of suitability. In various implementations, the entity may be a product.

In some implementations, the method may further include automatically generating training data for use in training the machine learning classifier. In some implementations, automatically generating training data may include evaluating one or more training textual statements using a language model. In some implementations, the method may further include comparing output of the language model to both an upper and lower threshold. In various implementations, the method may further include designating the one or more training textual statements as negative where output from the language model for those training textual statements indicates they are above the upper threshold or below the lower threshold.

Other implementations may include a non-transitory computer readable storage medium storing instructions executable by a processor to perform a method such as one or more of the methods described above. Yet another implementation may include a system including memory and one or more processors operable to execute instructions, stored in the memory, to perform a method such as one or more of the methods described above.

It should be appreciated that all combinations of the foregoing concepts and additional concepts described in greater detail herein are contemplated as being part of the subject matter disclosed herein. For example, all combinations of claimed subject matter appearing at the end of this disclosure are contemplated as being part of the subject matter disclosed herein.

### BRIEF DESCRIPTION OF THE DRAWINGS

FIG. 1 illustrates an example of how textual statements associated with an entity may be analyzed by various components of the present disclosure, so that one or more textual statements associated with the entity may be selected for presentation as a testimonial about the entity.

FIG. 2 depicts an example entity description and accompanying user comments, which accompanies explanation to illustrate how this data may be analyzed using selected aspects of the present disclosure.

FIG. 3 depicts a flow chart illustrating an example method of classifying user reviews and/or portions thereof, and associating extracted descriptive segments of text with various entities based on the classifications, in accordance with various implementations.

FIG. 4 depicts a flow chart illustrating an example first decision tree that may be employed to develop a suitable training set, in accordance with various implementations.

FIG. 5 depicts a flow chart illustrating an example second decision tree that may be employed, e.g., in conjunction with the decision tree of FIG. 4, to develop a suitable training set, in accordance with various implementations.

FIG. 6 schematically depicts an example architecture of a computer system.

### DETAILED DESCRIPTION

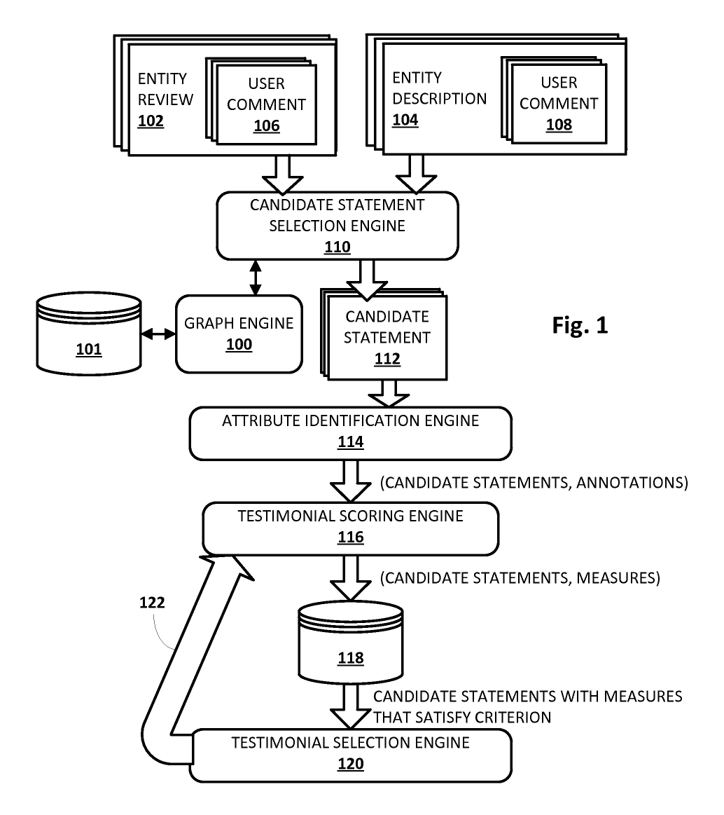

FIG. 1 illustrates an example of how textual statements associated with one or more entities may be analyzed by various components of the present disclosure, so that one or more textual statements associated with the one or more entities may be selected for presentation as a testimonial about the one or more entities. Various components illustrated in FIG. 1 may be implemented in one or more computers that communicate, for example, through one or more networks (not depicted). Various components illustrated in FIG. 1 may individually or collectively include memory for storage of data and software applications, one or more processors for accessing data and executing applications, and components that facilitate communication over a network. The operations performed by these components may be distributed across multiple computer systems. In various implementations, these components may be implemented as, for example, computer programs running on one or more computers in one or more locations that are coupled to each other through a network.

In FIG. 1, a graph engine 100 may be configured to build and maintain an index 101 of collections of “entities” and associated entity attributes. In various implementations, graph engine 100 may represent entities as nodes and relationships between entities as edges. In various implementations, graph engine 100 may represent collections of entities, entity attributes and entity relationships as directed or undirected graphs, hierarchal graphs (e.g., trees), and so forth. As used herein, an “entity” may generally be any person, organization, place, and/or thing. An “organization” may include a company, partnership, nonprofit, government (or particular governmental entity), club, sports team, a product vendor, a product creator, a product distributor, etc. A “thing” may include tangible (and in some cases fungible) products such as a particular model of tool, a particular model of kitchen or other appliance, a particular model of toy, a particular electronic model (e.g., camera, printer, headphones, smart phone, set top box, video game system, etc.), and so forth. A “thing” additionally or alternatively may include an intangible (e.g., downloadable) product such as software (e.g., the apps described above).

In this specification, the term “database” and “index” will be used broadly to refer to any collection of data. The data of the database and/or the index does not need to be structured in any particular way and it can be stored on storage devices in one or more geographic locations. Thus, for example, the indices 101 and/or 118 may include multiple collections of data, each of which may be organized and accessed differently.

As noted above, textual statements associated with entities may be obtained from various sources. In FIG. 1, for instance, a corpus of one or more entity reviews 102 and a corpus of one or more entity descriptions 104 are available. Textual statements associated with entities may of course be obtained from other sources (e.g., social networks, online forums, ad creatives), but for the sake of brevity, entity reviews and entity descriptions will be used as examples herein. In various implementations, entity reviews 102 and/or entity descriptions 104 may be accompanied by one or more user comments 106 and/or 108, respectively.

A candidate statement selection engine 110 may be in communication with graph engine 100. Candidate statement selection engine 110 may be configured to utilize various techniques to select, from entity reviews 102 and/or entity descriptions 104, one or more textual statements as candidate statements 112 about a particular entity documented in index 101. For example, the corpus of entity descriptions 104 may include descriptions of various apps available for download on an online marketplace. Candidate statement selection engine 110 may analyze each entity description using various techniques to identify a particular entity (or more than one entity) that the entity description is associated with. In some instances, candidate statement selection engine 110 may look at a title or metadata associated with the entity description 104 that indicates which entity it describes. In other instances, candidate statement selection engine 110 may use more complex techniques, such as a rules-based approach and/or one or more machine learning classifiers, to determine which entity an entity description 104 describes. Once an entity (or more than one entity) described in an entity description 104 is identified, various clauses, sentences, paragraphs, or even the whole description, may be selected as candidate statements 112 associated with that entity. Comments associated with a particular entity description 104 may also be selected as candidate statements 112 associated with that entity. A similar approach may be used for entity reviews 102 and their associated comments 106.

An attribute identification engine 114 may be configured to identify one or more attributes of candidate statements 112. In some implementations, such as in FIG. 1, attribute identification engine 114 may output versions of the candidate statements annotated with data indicative of these attributes, although this is not required. In other implementations, data indicative of the attributes may be output in other forms.

Attribute identification engine 114 may identify a variety of attributes of a candidate statement 112. For example, in some implementations, an inferred “sentiment orientation” associated with the candidate textual statement 112 may be determined, e.g., by attribute identification engine 114, based on content of the candidate textual statement 112. A “sentiment orientation” may refer to a general tone, polarity, and/or “feeling” of a particular candidate textual statement, e.g., positive, negative, neutral, etc. A sentiment orientation of a candidate textual statement may be determined using various sentiment analysis techniques, such as natural language processing, statistics, and/or machine learning to extract, identify, or otherwise characterize sentiment expressed by content of a candidate textual statement.

In some scenarios, candidate textual statements laced with sarcasm may not be suitable for presentation as testimonials. For example, a user comment (e.g., 106 or 108) that reads, “This camera has an amazing battery life, NOT!!” may not be suitable for presentation as a testimonial if the goal is to provide testimonials that will encourage consumers to purchase the camera. On the other hand, if the goal is to present testimonials casting light on aspects of the camera that are subpar, then such a testimonial may be more suitable. Accordingly, in some implementations, attribute identification engine may determine a measure of sarcasm expressed by one or more candidate textual statements 112.

A measure of sarcasm expressed by a candidate textual statement 112 may be determined using various techniques. In some embodiments, the sentiment orientation inferred from the content of the candidate textual statement may be compared to an explicit sentiment orientation associated with the candidate textual statement. For example, when leaving reviews or comments about an entity (e.g., an app or product on an online marketplace), users may assign a quantitative score to the entity, such as three of five stars, a letter grade, and so forth. That quantitative score may represent an explicit sentiment orientation associated with the candidate textual statement. If the explicit sentiment orientation is more or less aligned with the inferred sentiment orientation, then the candidate textual statement is not likely sarcastic. However, if the explicit and inferred sentiment orientations are at odds, then candidate textual statement may have a sarcastic tone.

For example, suppose a candidate textual statement reads, “This product is SO RELIABLE, I just can't wait to buy one for EACH MEMBER OF MY FAMILY so that they, too, can experience the UNMITIGATED joy this product has brought me,” but that an associated explicit sentiment orientation is indisputably negative, e.g., zero of five stars. The conflict between the inferred and explicit sentiment orientations in this example may demonstrate sarcasm, which attribute identification engine 114 may detect and/or annotate accordingly.

Attribute identification engine 114 may use other cues to detect sarcasm as well. For example, some users may tend to insert various punctuation clues for sarcasm, such as excessive capitalization. As another example, attribute identification engine 114 may compare inferred sentiment orientation associated with one candidate textual statement about an entity with an aggregate inferred sentiment orientation associated with that entity. If the lone and aggregate inferred sentiment orientations are vastly different, and especially if the sentiment orientation of the one candidate textual statement is positive and sentiment orientation of the rest of the candidate textual statements are negative, the one may be sarcastic. Other cues of sarcasm in a candidate textual statement may include, for instance, excessive hyperbole, or other tonal hints that may change as the nomenclature of the day evolves.

In some implementations, attribute identification engine 114 may identify and/or annotate particular words or phrases as being particularly indicative of sarcasm or some other sentiment orientation. For example, attribute identification engine 114 may maintain a “blacklist” of terms that it may annotate. Presence of one or more of these terms may cause various downstream components, such as testimonial selection engine 120, to essentially discard a candidate statement 112. For example, one or more of the following words, phrases, and/or emoticons may be included on a blacklist: “not,” “please,” “fix,” “sorry,” “couldn't,” “shouldn't,” “bad,” “ugly,” “can't,” “don't,” “update,” “but,” “previous,” “terrible,” “killed,” “?,” “waste,” “could,” “:(,” “:-(,” “refund,” “aren't,” “isn't,” “good good,” “love love,” “best best,” “work,” “otherwise,” “wouldn't,” “tablet,” and/or. Other words, phrases, and/or emoticons may be included on such a blacklist.

Attribute identification engine 114 may identify other attributes of a candidate statement 112. For example, in some implementations, attribute identification engine 114 may determine one or more structural details underlying the candidate textual statement. Structural details of a candidate textual statement 112 may include things like its metadata or its underlying HTML/XML. Metadata may include things like a source/author of the statement, the time the statement was made, and so forth.

As another example, attribute identification engine 114 may identify one or more characteristics of an entity expressed in a candidate textual statement 112. Various natural language processing techniques may be used, including but not limited to co-reference resolution, to identify characteristics of an entity expressed in a candidate. For example, suppose a candidate textual statement 112 associated with a particular product reads, “This product has a great feature X that I really like, and I also like how its custom battery is long lasting.” Attribute identification engine 114 may identify (and in some cases annotate the candidate textual statement 112 with) “feature X,” e.g., modified with “great,” as well as a “battery” modified by “custom” and “long-lasting.”

Testimonial scoring engine 116 may be configured to determine, based on attributes of one or more candidate textual statements 112 identified by attribute identification engine 114, a measure of suitability of the one or more candidate textual statements for presentation as one or more testimonials about the entity. A “measure of suitability for presentation as a testimonial,” or “testimonialness,” may be expressed in various quantitative ways, such as a numeric score, a percent, a ranking (if compared to other candidate textual statements), and so forth.

Testimonial scoring engine 116 may determine the measure of testimonialness in various ways. In some implementations, testimonial scoring engine 116 may weight various attributes of candidate textual statements 112 identified by attribute identification engine 114 differently. For example, if a particular candidate textual statement 112 is annotated as having a positive inferred sentiment orientation, and positive testimonials are sought, then that candidate receive a relatively high measure of testimonialness. On the other hand, the fact that a particular candidate textual statement 112 is annotated as being sarcastic may weigh heavily against its being suitable for presentation as a testimonial (unless, of source, sarcastic testimonials are desired). One or more blacklisted terms in candidate textual statement 112 may also weigh against it being deemed suitable for presentation as a testimonial. Structural details of candidate textual statements 112 may also be weighted, e.g., based on various information. For example, suppose a product received generally negative reviews prior to an update, but after the update (which may have fixed a problem with the product), the reviews started being generally positive. Testimonial scoring engine 116 may assign more weight to candidate textual statements 112 that are dated after the update than before. Additionally or alternatively, testimonial scoring engine 116 may weight candidate textual statements 112 differently depending on their level of “staleness”; e.g., newer statements may be weighted more heavily.

In some implementations, testimonial scoring engine 116 may compare one or more identified characteristics of the entity expressed in a candidate textual statement 112 with known characteristics of the entity. The more these identified and known characteristics match, the higher the measure of suitability for presentation as a testimonial may be. Conversely, if characteristics of an entity expressed in a candidate textual statement 112 are contradictory (e.g., candidate statement says product X has feature Y, whereas it is known that product X does not have feature Y), testimonial scoring engine 116 may determine a lower measure of suitability for presentation as a testimonial.

Known characteristics about an entity may include various things, including but not limited to the entity's name, creator (e.g., if a product), one or more identifiers (e.g., serial numbers, model numbers), a type, a genre, a price, a rating, etc. The more words or phrases contained in a candidate textual statement 112 that are the same as, or similar to (e.g., synonymous with), words or phrases that constitute known characteristics of an entity, in some implementations, the more suitable the candidate textual statement 112 may be for presentation as a testimonial. Some known characteristics may be weighed more heavily if found in a candidate textual statement 112 than others. For example, a product creator may receive less weight than, for instance, a product name, if testimonial scoring engine 116 is determining suitability for presentation as a testimonial about the product.

In some implementations, testimonial scoring engine 116 may use one or more machine learning classifiers to determine what measures of suitability for presentation as testimonials to assign to candidate textual statements. These one or more machine learning classifiers may be trained using various techniques. In some implementations, a corpus of training data may include a corpus of entity descriptions 104. The machine learning classifier may be trained using portions of entity descriptions 104 deemed likely to be suitable for presentation as a testimonial about the associated entity. For example, different weights may be assigned to different portions of the entity descriptions 104 based on locations of the different portions within the entity descriptions.

For example, it may be the case that, in app descriptions on an online marketplace, the first sentence of the description tends to be well suited for presentation as a testimonial. The first sentence may summarize the app, describe its main features, and/or express other ideas that are of the type that might be usefully presented in testimonials. In such implementations, the predetermined locations within the entity descriptions 104 that are considered especially likely to be suitable for presentation as a testimonial may include first sentences of the entity descriptions 104.

In some implementations, more complex formulas may be employed. For example, in some implementations, an equation such as the following may be employed to determine a weight to assign an ith sentence in an entity description:

∀i∈N⁺: i≤C,2⁻ⁱ

N⁺ means positive integers and C may be an integer selected based on, for instance, empirical evidence suggesting that sentences i of an entity description 104 where i>C (e.g., after the Cth sentence) are unlikely to be suitable for presentation as testimonials, or at least should not be presumed suitable for presentation as a testimonial. Thus, using this formula, the first sentence would be weighed more heavily than the second, the second more heavily than the third, and so forth.

Once trained using sentences or phrases at locations deemed likely to contain textual statements with high testimonial-ness, testimonial scoring engine 116 may analyze candidate textual statements 112 to determine how close they are to those sentences. The more a candidate textual statement 112 is like those sentences of entity descriptions 104, the more suitable for presentation as a testimonial that candidate textual statement 112 may be.

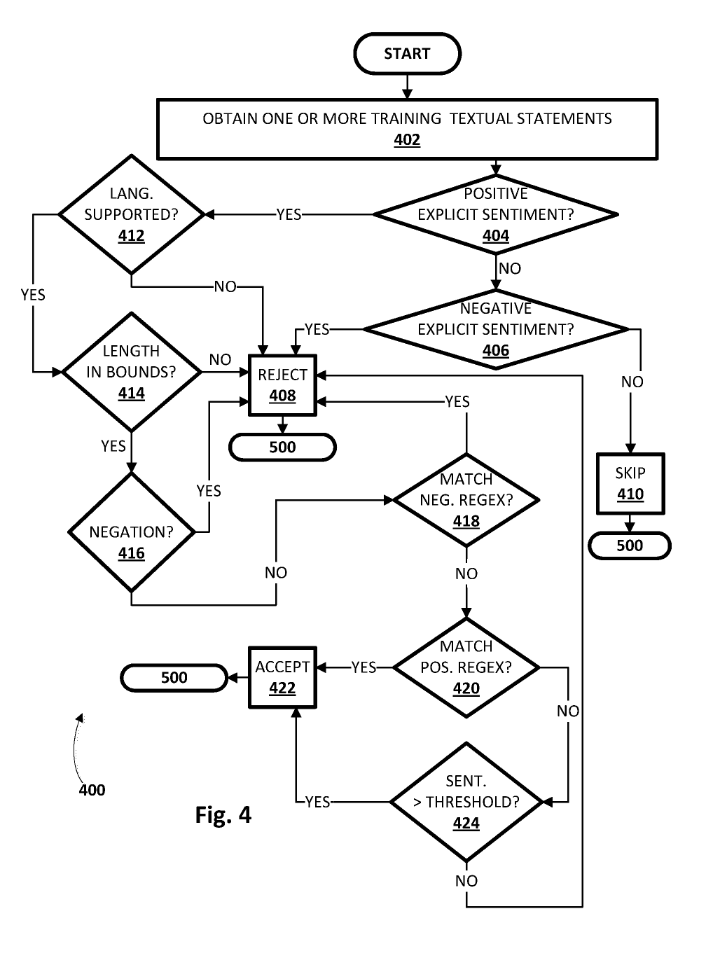

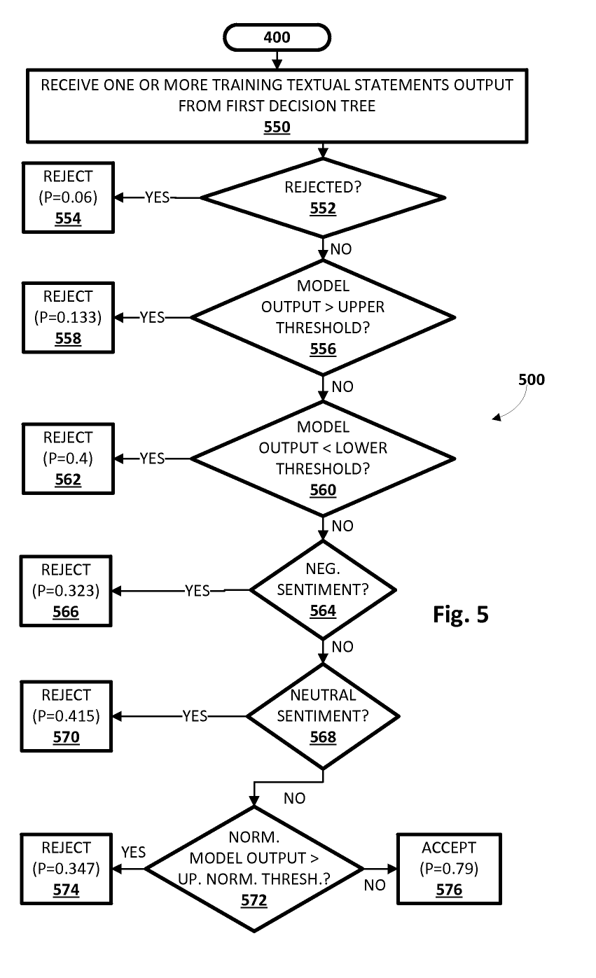

Machine learning classifiers utilized by testimonial scoring engine 116 may be trained in other ways as well. For example, entity descriptions 104 may include sentences and/or phrases in quotations, such as quotes from critical reviews of the entity, and/or sentences or phrases having a particular format (e.g., bold, italic, larger font, colored, etc.). These sentences or phrases may be deemed more likely to be suitable for presentation as testimonials than other sentences or phrases not contained in quotes, and thus may be used to train the classifier as to what a testimonial looks like. In other implementations, techniques such as those depicted in FIGS. 4 and 5 may be used to automatically develop training data.

In some implementations, testimonial scoring engine 116 may utilize other formulas to score candidate textual statement 112. For example, testimonial scoring engine 116 may utilize the following equation:

score=NLP SENTIMENT POLARITY+X+0.5×CS

wherein NLP_SENTIMENT_POLARITY is a measure of sentiment orientation of candidate textual statement 112, “X” is a value indicative of presence or absence of one or more categories of sentiment in candidate textual statement 112, and “CS” is a Cartesian similarity of candidate textual statement 112 to an entity description.

In various implementations, testimonial scoring engine 116 may output candidate textual statements and measures of suitability for those candidate textual statements to be presented as testimonials. In some implementations, that data may be stored in an index 118, e.g., so that it can be used by various other components as needed. For example, a testimonial selection engine 120 may be configured to select one or more testimonials for presentation, e.g., as an accompaniment for an advertisement or search engine results. In some implementations, testimonial selection engine 120 may be informed of a particular entity for which an advertisement or search results will be displayed, and may select one or more candidate textual statements 112 associated with that entity that have the greatest measures of suitability for presentation as testimonials.

In some implementations, testimonial selection engine 120 may be configured to provide feedback 122 or other data to other components such as testimonial scoring engine 116. For example, suppose testimonial selection engine 120 determines that candidate textual statements 112 associated with a particular entity that are stored in index 118 are stale (e.g., more than n days/weeks/months/years old). Testimonial selection engine 120 may notify testimonial scoring engine 116 (or another component), and those components may collect new candidate textual statements for analysis and/or reevaluate existing candidate textual statements 112.

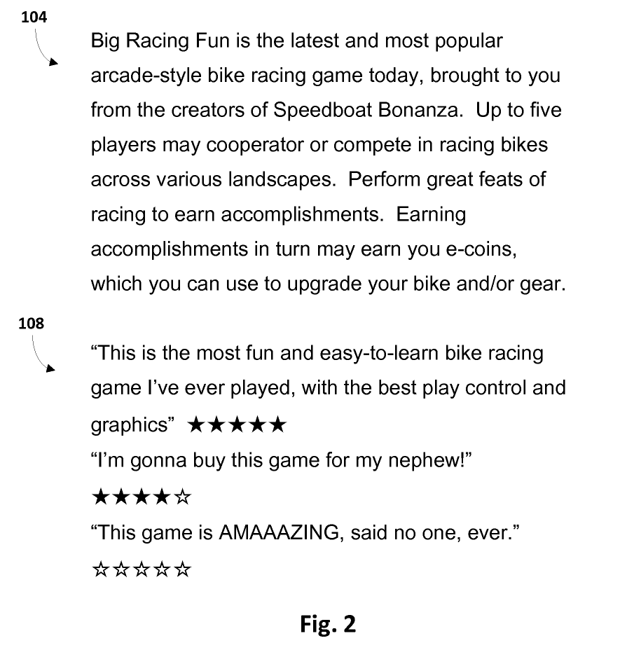

FIG. 2 depicts an example entity description 104 and accompanying user comments 108 for an app called “Big Racing Fun.” The first sentence, which reads “Big Racing Fun is the latest and most popular arcade-style bike racing game today, brought to you from the creators of Speedboat Bonanza,” as well as other sentences/phrases from entity description 104, may have be used in some implementations to train one or more machine learning classifiers.

The first user comment reads “This is the most fun and easy-to-learn bike racing game I've ever played, with the best play control and graphics.” In some implementations, this comment, which may be analyzed as a candidate textual statement 112, may receive a relatively high measure of suitability for presentation as a testimonial. It describes some of the product's known features (e.g., bike racing, good play control, good graphics). It has a positive tone, which may lead to an inference that its sentiment orientation is positive. That matches its explicit sentiment orientation (five out of five stars), so it is not sarcastic. And it somewhat resembles the first sentence of the entity description 104 because, for instance, in mentions many of the same words.

The second user comment, “I'm gonna buy this game for my nephew!”, may receive a slightly lower score. It's not particularly informative, other than a general inference of positive sentiment orientation. If it said how old the nephew was, then it might be slightly more useful to other users with nieces/nephews of a similar age, but it doesn't. Depending on how many other more suitable candidate textual statements there are, this statement may or may not be selected for presentation as a testimonial.

The third user comment, “This game is AMAAAZING, said no one, ever,” may receive a lower score than the other two, for several reasons. While its inferred sentiment orientation could feasibly be positive based on the variation of the word “amazing,” its explicit sentiment orientation is very negative (zero of five stars), which is highly suggestive of sarcasm. It also includes capitalized hyperbole (“AMAAAZING”)—another potential sign of sarcasm. And, it includes a phrase, “said no one, ever,” that may be part of a modern vernacular known to intimate sarcasm.

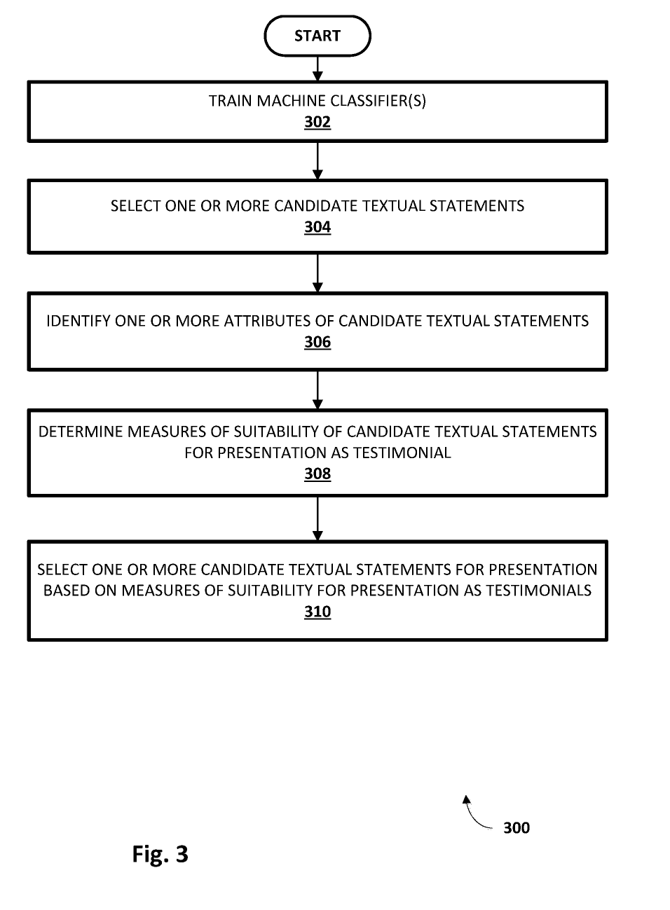

Referring now to FIG. 3, an example method 300 of selecting textual statements for presentation as testimonials is described. For convenience, the operations of the flow chart are described with reference to a system that performs the operations. This system may include various components of various computer systems. Moreover, while operations of method 300 are shown in a particular order, this is not meant to be limiting. One or more operations may be reordered, omitted or added.

In some implementations, at block 302, the system may train one or more machine learning classifiers. Various training data may be used. In some implementations, and as mentioned above, entity descriptions may be used, with various phrases or sentences being weighted more or less heavily depending on, for instance, their locations within the entity descriptions, their fonts, and so forth. In other implementations, other training data, such as collections of textual segments known to be suitable for use as testimonials, may be used instead. In some implementations, training data may be automatically developed, e.g., using techniques such as those depicted in FIGS. 4-5.

At block 304, the system may select, from one or more electronic data sources (e.g., blogs, user review sources, social networks, comments associated therewith, etc.) a candidate textual statement associated with an entity. At block 306, the system may identify one or more attributes of the candidate textual statement. For example, the system may annotate the candidate textual statement with various information, such as whether the textual statement contains sarcasm, one or more entity characteristics expressed in the statement, one or more facts about the structure (e.g., metadata) about the statement, and so forth.

At block 308, the system may determine, based on the identified one or more attributes of the candidate textual statement, a measure of suitability of the candidate textual statement for presentation as a testimonial about the entity. As noted above, this may be performed in various ways. In some implementations, one or more machine learning classifiers may be employed to analyze the candidate textual statement against, for instance, first sentences of a corpus of entity descriptions used as training data, or against training sets of statements for which testimonial suitability are known. In some implementations, entity characteristics expressed in a candidate textual statement may be compared to known entity characteristics to determine, for instance, an accuracy or descriptiveness of the candidate textual statement. In some implementations, one or more structural details of a candidate textual statement may be analyzed, for instance, to determine how stale the statement is.

At block 310, the system may select, e.g., based on the measure of suitability for presentation as a testimonial determined at block 308, the candidate textual statement for presentation as a testimonial about the entity. For instance, suppose the system has selected an advertisement for presentation to a user, wherein the advertisement relates to a particular product. The system may select, based on measures of suitability for presentation as testimonials, one or more testimonials to present to the user, e.g., adjacent to the advertisement, or as part of an advertisement that is generated on the fly.

Determining whether candidate textual statements are suitable for use as testimonials may be trivial for a human being. However, developing clear guidelines or properties for use by one or more computers to identify suitable testimonials may be challenging given the unconstrained nature of written language, among other things. Accordingly, in various implementations, various techniques may be employed to automatically develop training data that may be used, for instance, to train one or more machine learning classifiers (e.g., at block 302). Examples of such techniques are depicted in FIGS. 4 and 5. For convenience, the operations of the FIGS. 4 and 5 are described with reference to a system that performs the operations. This system may include various components of various computer systems. Moreover, while operations of methods 400 and 500 are shown in a particular order, this is not meant to be limiting. One or more operations may be reordered, omitted or added.

Referring to FIG. 4, at block 402, the system may obtain one or more training textual statements, e.g., from the various sources depicted in FIG. 1 or elsewhere. At block 404, the system may determine, for each statement, whether the statement has a positive explicit sentiment. For example, does the statement come from a review with at least four out of five stars? If the answer at block 404 is no, then the system may determine at block 406 whether the statement has a negative explicit sentiment. For example, does the statement come from a review with less than three of five stars? If the answer at block 406 is yes, then method 400 proceed to block 408, and the training textual statement may be rejected. In some implementations, “rejecting” a training textual statement may include classifying the statement as “negative,” so that it can be used as a negative training example for one or more machine learning classifiers. If the answer at block 406 is no, then the statement apparently is from a neutral or unknown source, and therefore is skipped at block 410. In various implementations, “skipping” a statement may mean classifying the statement as “neutral,” so that it can be used (or ignored or discarded) as a neutral training example for one or more machine learning classifiers.

Back at block 404, if the answer is yes, then the system determines whether the language of the statement is supported. For example, if the system is configured to analyze languages A, B, and C, but the training textual statement is not in any of these languages, then the system may reject the statement at block 408. If, however, the training textual statement is in a supported language, then method 400 may proceed to block 414.

At block 414, the system may determine whether a length of the training statement is “in bounds,” e.g., by determining whether its length satisfies one or more thresholds for word or character length. If the answer at block 414 is no, then method 400 may proceed to block 408 and the training statement may be rejected. However, if the answer at block 414 is yes, then method 400 may proceed to block 416. At block 416, the system may determine whether the training statement contains any sort of negation language (e.g., “not,” “contrary,” “couldn't,” “don't,” etc.). If the answer is yes, then the system may reject the statement at block 408. However, if the answer is no, then method 400 may proceed to block 418.

At block 418, the system may determine whether the training textual statement matches one or more negative predetermined patterns, such as a negative regular expression. These negative predetermined patterns may be configured to identify patterns found in training textual statements that are known (to a relatively high degree of confidence) not to be suitable for presentation as testimonials. If the answer is yes, then the statement may be rejected at block 408. If the answer at block 418 is no, then method 400 may proceed to block 420 where it is determined whether the statement matches one or positive predetermined patterns, such as a positive regular expression. These positive predetermined patterns may be configured to identify patterns found in training textual statements that are known (to a relatively high degree of confidence) to be suitable for presentation as testimonials. If the answer at block 420 is yes, then the statement may be accepted at block 422. In various implementations, “accepting” a statement may include classifying the statement as a positive training example for use by one or more machine learning classifiers.

If the answer at block 420 is no, then method 400 may proceed to block 424, at which the system may determine whether a sentiment orientation of the statement (e.g., which may be inferred using various techniques described above) satisfies a particular threshold. If the answer is no, then method 400 may proceed to block 408, and the statement may be rejected. If the answer at block 424 is yes, then method may proceed to block 422, at which the statement is accepted. As shown at blocks 408, 410, and 422, rejected, neutral, and accepted statements may be further processed using the various techniques employed in method 500 of FIG. 5.

Referring now to FIG. 5, at block 550, the system may receive or otherwise obtain one or more training textual statements output and/or annotated (e.g., as “positive,” “neutral,” “negative”) by the first decision tree of FIG. 4 (i.e., method 400). At block 552, the system may determine whether the statement was rejected (e.g., at block 408). If the answer is yes, then the statement may be further rejected at block 554 (e.g., classified as a negative training example) and/or may be assigned a probability score, p, of 0.06. This probability score may be utilized by one or more machine learning classifiers as a weighted negative or positive training example to facilitate more fine-tuned analysis training textual statements. In some implementations, the system may determine whether a resulting probability score satisfies one or more thresholds, such as 0.5. In some such embodiments, if the threshold is satisfied, the textual statement may be classified as a “positive” training example. If the threshold is not satisfied, the textual statement may be classified as a “negative” training example. At block 554, p may be assigned a score of 0.06, which puts it far below a minimum threshold of 0.5.

Back at block 552, if the answer is no, then method 500 may proceed to block 556. At block 556, the system may determine whether the training textual statement, when used as input for one or more language models, yields an output that satisfies an upper threshold. For instance, various language models may be employed to determine a measure of how well-formed a training textual statement is. If the training textual statement is “too” well-formed, then it may be perceived as puffery (e.g., authored by or on behalf of an entity itself), rather than an honest human assessment. Puffery may not be suitable for use as a testimonial. If the answer at block 556 is yes, then method 500 may proceed to block 558, at which the training textual statement may be rejected. In some implementations, probability score p may be assigned various values, such as 0.133, which is somewhat closer to the threshold (e.g., 0.5) than the probability score p=0.06 assigned at block 554. If the answer at block 556 is no, then method 500 may proceed to block 560.

At block 560, the system may system may determine whether the training textual statement, when used as input for one or more language models, yields an output that satisfies a lower threshold. For instance, if the training textual statement is not well-formed enough, then it may be perceived as uninformative and/or unintelligible. Uninformative or unintelligent-sounding statements may not be suitable for use as testimonials, or may be somewhat less useful than other statements, at any rate. If the answer at block 560 is yes, then method 500 may proceed to block 562, at which the training textual statement may be rejected. In some implementations, probability score p may be assigned various values, such as 0.4, which is somewhat closer to the threshold (e.g., 0.5) than the probability scores assigned at blocks 554 and 558. This may be because, for instance, an unintelligent sounding statement, while not ideal for use as a testimonial, may be more suitable than puffery. If the answer at block 560 is no, then method 500 may proceed to block 564.

At block 564, the system may determine whether the statement has a negative sentiment orientation, e.g., using techniques described above. If the answer is yes, then method 500 may proceed to block 566, at which the statement may be rejected. In some implementations, at block 566, p may be assigned a value such as 0.323, which reflects that statements of negative sentiment are not likely suitable for use as testimonials. If the answer at block 564 is no, however, then method 500 may proceed to block 568.

At block 568, the system may determine whether the statement has a neutral sentiment orientation, e.g., using techniques described above. If the answer is yes, then method 500 may proceed to block 570, at which the statement may be rejected. In some implementations, at block 570, p may be assigned a value such as 0.415. This reflects that while a neutral statement may not be ideal for use as a testimonial, it still be may better suited than, say, a negative statement as determined at block 566. If the answer at block 568 is no, however, then method 500 may proceed to block 572.

At block 572, the system may compare normalized output of one or more language models that results from input of the training textual statement to one or more normalized upper thresholds. For example, language model computation may calculate “readability” using a formula such as the following:

−log Πᵢ₌₁ⁿPr(Xᵢ|_{1, . . . , n-1})

where n is equal to a number of probabilities. However, the above formula may tend to score longer training textual statements as less readable than longer statements. Accordingly, normalizing lengths of training textual statements may yield a formula that may be used to compare phrases of different lengths, such as the following:

$$( - \frac{1}{n} ) log {\prod }_{i = 1}^{n} Pr ( {X}_{i} \vert {X}_{1 , … , n - 1} )$$

At block 572, if the normalized upper threshold is satisfied, then method 500 may proceed to block 574, at which the training statement may be rejected and/or assigned a probability score p=0.347. If the answer at block 572 is no, however, then at block 576, the training statement may be accepted (e.g., classified as a positive training example). In some implementations, at block 576, the system may assign the training statement a relatively high probability score, such as p=0.79.

In various implementations, candidate and/or training textual statements may be represented in various ways. In some implementations, a textual statement and/or statement selected for use as a testimonial may be represented as a “bag of words,” a “bag of tokens,” or even as a “bag of regular expressions.” Additionally or alternatively, a bag of parts of speech tags, categories, labels, and/or semantic frames may be associated with textual statements. Various other data may be associated with statements, including but not limited to information pertaining to a subject entity (e.g., application name, genre, creator), an indication of negation, one or more sentiment features (which may be discretized), text length, ill-formed ratio, punctuation ratio (which may be discretized), and/or a measure of how well-formed a statement is determined, for instance, from operation of a language model.

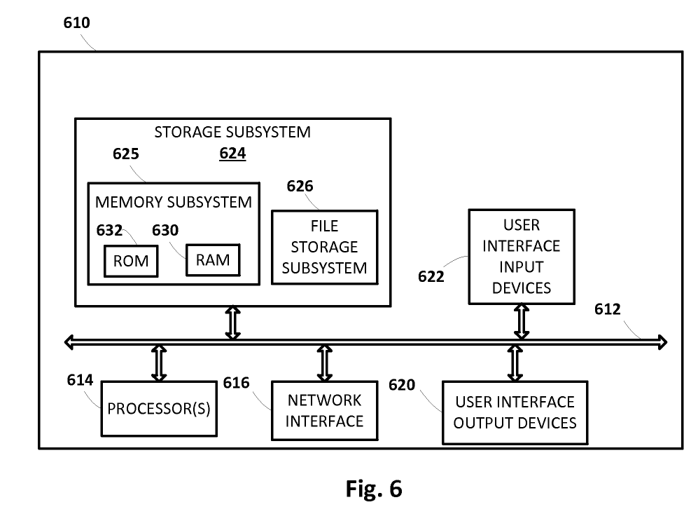

FIG. 6 is a block diagram of an example computer system 610. Computer system 610 typically includes at least one processor 614 which communicates with a number of peripheral devices via bus subsystem 612. These peripheral devices may include a storage subsystem 624, including, for example, a memory subsystem 625 and a file storage subsystem 626, user interface output devices 620, user interface input devices 622, and a network interface subsystem 616. The input and output devices allow user interaction with computer system 610. Network interface subsystem 616 provides an interface to outside networks and is coupled to corresponding interface devices in other computer systems.

User interface input devices 622 may include a keyboard, pointing devices such as a mouse, trackball, touchpad, or graphics tablet, a scanner, a touchscreen incorporated into the display, audio input devices such as voice recognition systems, microphones, and/or other types of input devices. In general, use of the term “input device” is intended to include all possible types of devices and ways to input information into computer system 610 or onto a communication network.

User interface output devices 620 may include a display subsystem, a printer, a fax machine, or non-visual displays such as audio output devices. The display subsystem may include a cathode ray tube (CRT), a flat-panel device such as a liquid crystal display (LCD), a projection device, or some other mechanism for creating a visible image. The display subsystem may also provide non-visual display such as via audio output devices. In general, use of the term “output device” is intended to include all possible types of devices and ways to output information from computer system 610 to the user or to another machine or computer system.

Storage subsystem 624 stores programming and data constructs that provide the functionality of some or all of the modules described herein. For example, the storage subsystem 624 may include the logic to perform selected aspects of method 300, 400, and/or 500, and/or to implement one or more of candidate statement selection engine 110, graph engine 100, attribute identification engine 114, testimonial scoring engine 116, and/or testimonial selection engine 120.

These software modules are generally executed by processor 614 alone or in combination with other processors. Memory 625 used in the storage subsystem 624 can include a number of memories including a main random access memory (RAM) 630 for storage of instructions and data during program execution and a read only memory (ROM) 632 in which fixed instructions are stored. A file storage subsystem 626 can provide persistent storage for program and data files, and may include a hard disk drive, a floppy disk drive along with associated removable media, a CD-ROM drive, an optical drive, or removable media cartridges. The modules implementing the functionality of certain implementations may be stored by file storage subsystem 626 in the storage subsystem 624, or in other machines accessible by the processor(s) 614.

Bus subsystem 612 provides a mechanism for letting the various components and subsystems of computer system 610 communicate with each other as intended. Although bus subsystem 612 is shown schematically as a single bus, alternative implementations of the bus subsystem may use multiple busses.

Computer system 610 can be of varying types including a workstation, server, computing cluster, blade server, server farm, or any other data processing system or computing device. Due to the ever-changing nature of computers and networks, the description of computer system 610 depicted in FIG. 6 is intended only as a specific example for purposes of illustrating some implementations. Many other configurations of computer system 610 are possible having more or fewer components than the computer system depicted in FIG. 6.

In situations in which the systems described herein collect personal information about users, or may make use of personal information, the users may be provided with an opportunity to control whether programs or features collect user information (e.g., information about a user's social network, social actions or activities, profession, a user's preferences, or a user's current geographic location), or to control whether and/or how to receive content from the content server that may be more relevant to the user. Also, certain data may be treated in one or more ways before it is stored or used, so that personal identifiable information is removed. For example, a user's identity may be treated so that no personal identifiable information can be determined for the user, or a user's geographic location may be generalized where geographic location information is obtained (such as to a city, ZIP code, or state level), so that a particular geographic location of a user cannot be determined. Thus, the user may have control over how information is collected about the user and/or used.

While several implementations have been described and illustrated herein, a variety of other means and/or structures for performing the function and/or obtaining the results and/or one or more of the advantages described herein may be utilized, and each of such variations and/or modifications is deemed to be within the scope of the implementations described herein. More generally, all parameters, dimensions, materials, and configurations described herein are meant to be exemplary and that the actual parameters, dimensions, materials, and/or configurations will depend upon the specific application or applications for which the teachings is/are used. Those skilled in the art will recognize, or be able to ascertain using no more than routine experimentation, many equivalents to the specific implementations described herein. It is, therefore, to be understood that the foregoing implementations are presented by way of example only and that, within the scope of the appended claims and equivalents thereto, implementations may be practiced otherwise than as specifically described and claimed. Implementations of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the scope of the present disclosure.

1. A computer-implemented method, comprising:
selecting, by one or more processors from one or more electronic data sources, a candidate textual statement composed by an individual that describes a product or service;
determining, by one or more of the processors based on content of the candidate textual statement, an inferred sentiment orientation associated with the candidate textual statement;
comparing, by one or more of the processors, the inferred sentiment orientation of the candidate textual statement to an explicit rating applied to the product or service by the individual to determine a measure of alignment between the inferred sentiment orientation and the explicit rating;
determining, by one or more of the processors based at least in part on the measure of alignment, a measure of suitability of the candidate textual statement for presentation as a testimonial that describes the product or service, wherein determining the measure of suitability further includes applying the candidate textual statement as input across a trained machine learning classifier to generate output, wherein the trained machine learning classifier is trained using portions of entity descriptions labeled suitable for presentation as a testimonials about products or services, wherein the measure of suitability is further determined based on the output of the trained machine learning model;
determining that the measure of suitability satisfies a threshold;
in response to determining that the measure of suitability satisfies a threshold, storing, by one or more of the processors, the candidate textual statement and the associated measure of suitability in one or more databases;
receiving, by one or more of the processors, from a remote computing device operated by a user, a search query;
determining, by one or more of the processors, that the search query relates to the product or service; and
providing, to the remote computing device, in conjunction with content related to the product or service that is responsive to the search query, the candidate textual statement from the one or more databases; wherein the providing causes the candidate textual statement to be presented as output at the remote computing device operated by the user.

2-3. (canceled)

4. The computer-implemented method of claim 1, further comprising determining, by one or more of the processors, one or more structural details underlying the candidate textual statement.

5. The computer-implemented method of claim 1, further comprising identifying, by one or more of the processors, one or more characteristics of the product or service expressed in the candidate textual statement.

6. The computer-implemented method of claim 5, wherein determining the measure of suitability further comprises comparing, by one or more of the processors, the one or more identified characteristics of the product or service expressed in the candidate textual statement with known characteristics of the product or service.

7-8. (canceled)

9. The computer-implemented method of claim 1, wherein the portions of entity descriptions labeled suitable for presentation as a testimonial about the product or service include portions at predetermined locations within the entity descriptions.

10. The computer-implemented method of claim 9, wherein the predetermined locations within the entity descriptions include first sentences of the entity descriptions.

11. The computer-implemented method of claim 9, wherein training the machine learning classifier comprises assigning different weights to different portions of the entity descriptions based on locations of the different portions within the entity descriptions.

12. The computer-implemented method of claim 1, wherein the portions of entity descriptions labeled suitable for presentation as a testimonial about the product or service include portions enclosed in quotations or having a particular format.

13. The computer-implemented method of claim 1, further comprising selecting, by one or more of the processors, the candidate textual statement from a plurality of candidate textual statements for presentation as a testimonial about the product or service based on the measure of suitability.

14. The computer-implemented method of claim 7, further comprising automatically generating training data for use in training the machine learning classifier.

15. The computer-implemented method of claim 14, wherein automatically generating training data comprises evaluating one or more training textual statements using a language model.

16. The computer-implemented method of claim 15, further comprising comparing output of the language model to both an upper and lower threshold.

17. The computer-implemented method of claim 16, further comprising designating the one or more training textual statements as negative where output from the language model for those training textual statements indicates they are above the upper threshold or below the lower threshold.

18. (canceled)

19. A system including memory and one or more processors operable to execute instructions stored in the memory, comprising instructions to perform the following operations:
selecting, from one or more electronic data sources, a candidate textual statement composed by an individual that describes a product or service;
determining, based on content of the candidate textual statement, an inferred sentiment orientation associated with the candidate textual statement;
comparing the inferred sentiment orientation of the candidate textual statement to an explicit rating applied to the product or service by the individual to determine a measure of alignment between the inferred sentiment orientation and the explicit rating;
determining, based at least in part on the measure of alignment, a measure of suitability of the candidate textual statement for presentation as a testimonial that describes the product or service, wherein determining the measure of suitability further includes applying the candidate textual statement as input across a trained machine learning classifier to generate output, wherein the trained machine learning classifier is trained using portions of entity descriptions labeled suitable for presentation as a testimonials about products or services, wherein the measure of suitability is further determined based on the output of the trained machine learning model;
determining that the measure of suitability satisfies a threshold;
in response to determining that the measure of suitability satisfies a threshold, storing the candidate textual statement and the associated measure of suitability in one or more databases;
receiving, from a remote computing device operated by a user, a search query;
determining that the search query relates to the product or service; and
providing, to the remote computing device, in conjunction with content related to the product or service that is responsive to the search query, the candidate textual statement from the one or more databases; wherein the providing causes the candidate textual statement to be presented as output at the remote computing device operated by the user.

20. (canceled)

21. The system of claim 19, further comprising instructions to determine one or more structural details underlying the candidate textual statement.

22. The system of claim 19, further comprising instructions to identify one or more characteristics of the product or service expressed in the candidate textual statement, and to compare one or more identified characteristics of the product or service expressed in the candidate textual statement with known characteristics of the product or service.

23-24. (canceled)

25. At least one non-transitory computer-readable medium comprising instructions that, in response to execution of the instructions by a computing system, cause the computing system to perform the following operations:
selecting, from one or more electronic data sources, a candidate textual statement composed by an individual that describes a product or service;
determining, based on content of the candidate textual statement, an inferred sentiment orientation associated with the candidate textual statement;
comparing the inferred sentiment orientation of the candidate textual statement to an explicit rating applied to the product or service by the individual to determine a measure of alignment between the inferred sentiment orientation and the explicit rating;
determining, based on the measure of alignment, a measure of suitability of the candidate textual statement for presentation as a testimonial about the product or service;
determining that the measure of suitability satisfies a threshold;
in response to determining that the measure of suitability satisfies a threshold, storing the candidate textual statement and the associated measure of suitability in one or more databases;
receiving, from a remote computing device operated by a user, a search query;
determining that the search query relates to the product or service; and
providing, to the remote computing device, in conjunction with content related to the product or service that is responsive to the search query, the candidate textual statement from the one or more databases; wherein the providing causes the candidate textual statement to be presented as output at the remote computing device operated by the user.
